(19) United States
(12) Patent Application Publication
(10) Pub. No.: US 2005/0218771 A1
(43) Pub. Date: Oct. 6, 2005

(54) Spark plug

(76) Inventors: Klaus Hrastnik, Stuttgart (DE); Andreas Benz, Bamberg (DE); Thomas Kaiser, Stuttgart (DE); Ruediger Zeitler, Renningen (DE)

Correspondence Address: KENYON & KENYON, ONE BROADWAY, NEW YORK, NY, 10004, US

(21) Appl. No.: 11/081,450

(22) Filed: Mar. 16, 2005

(30) Foreign Application Priority Data
Apr. 3, 2004 (DE) 102004016555.6

(51) Int. Cl. H01T 13/20

(52) U.S. Cl. 313/141

(57) ABSTRACT

A spark plug includes a housing on which a ground electrode is fixed. The spark plug includes an insulator situated in the housing, which has a longitudinal bore having a center electrode. The ground electrode has a core and a jacket, the material of the core having a higher heat conductivity than the material of the jacket. The cross sectional area of the core amounts, at least from section to section, to at least 40 percent of the cross sectional area of the ground electrode.

### BACKGROUND INFORMATION

A spark plug is described, for example, in German Patent Application No. DE 44 24 789. The spark plug has a housing in which there is an insulator having a longitudinal bore hole. In the longitudinal bore hole a mid-point conductor is provided which includes a connecting bolt and a center electrode. A ground electrode is fastened to the housing. By the application of a high voltage, a spark gap forms between the ground electrode and the center electrode. The ground electrode is developed as a composite member, and has a copper core that is surrounded by a jacket. The jacket is made, for instance, of nickel. The ground electrode is manufactured by extrusion. In such spark plugs, the cross sectional area of the copper core amounts to at most 20 percent of the cross sectional area of the ground electrode. In operation in an internal combustion engine, the ground electrode is heated to very high temperatures. In this connection it is a disadvantage that at such high temperatures corrosion processes and spark erosion removal occur in a reinforced manner on the ground electrode. In addition, the durability of welded connections becomes worse, which are used, for example, for fastening a noble metal section to the ground electrode.

### SUMMARY OF THE INVENTION

The spark plug according to the present invention has the advantage that the ground electrode heats up in operation to only comparatively low temperatures, even under extreme conditions. This avoids overheating of the ground electrode. Because of the lower temperature, the corrosion and the spark erosion removal also become less. At a lower operating temperature of the ground electrode, there is also an improvement in the hardenability of a welding connection between the jacket of the ground electrode and a noble metal tip welded on at the end section of the ground electrode. Furthermore, the ground electrode is easier to bend into the desired position during the manufacture of the spark plug.

According to the present invention, it is provided that the cross sectional area of the core of the ground electrode, whose material has a higher heat conductivity than the material of the jacket of the ground electrode that surrounds the core, amounts at least from region to region to 40 percent of the corresponding cross sectional area of the ground electrode. By this it is achieved that the heat dissipation via the core of the ground electrode into the housing of the spark plug is improved. The cross sectional area is understood to mean the area perpendicular to the longitudinal extension of the ground electrode.

Advantageously, the cross sectional area of the core amounts to at least 40 percent, particularly at least 50 percent of the cross sectional area of the ground electrode, and it does so over at least half the length of the ground electrode. The length of the ground electrode or of the core of the ground electrode, in the case of a bent electrode, is understood to mean the length of the ground electrode unrolled onto a plane.

Advantageously, the core of the ground electrode extends up to the housing, so that the heat conduction via the well-heat conducting core of the ground electrode into the housing is improved.

The length of the core amounts preferably to at least 70 percent of the length of the ground electrode. Also advantageously, the cross sectional area of the core of the ground electrode is at least largely constant over at least 70 percent of its longitudinal extension, i.e. the cross sectional area of the core undergoes in this region fluctuations of at most 1 percent. In this region, the wall strength of the jacket is advantageously in the range of 0.25 to 0.40 mm, particularly near 0.30 mm.

The material of the core of the ground electrode advantageously has a heat conductivity of at least 350 W/mK at room temperature. At room temperature, the heat conductivity of the material of the core of the ground electrode is also advantageously greater by 300 W/mK than the heat conductivity of the material of the jacket of the ground electrode.

### BRIEF DESCRIPTION OF THE DRAWINGS

FIG. 1 shows a spark plug according to the present invention in a partial sectional representation.

FIG. 2 shows a ground electrode of the spark plug according to the present invention in a longitudinal section, unrolled onto a plane.

FIG. 3 shows a section through the ground electrode according to line III-III in FIG. 2.

### DETAILED DESCRIPTION

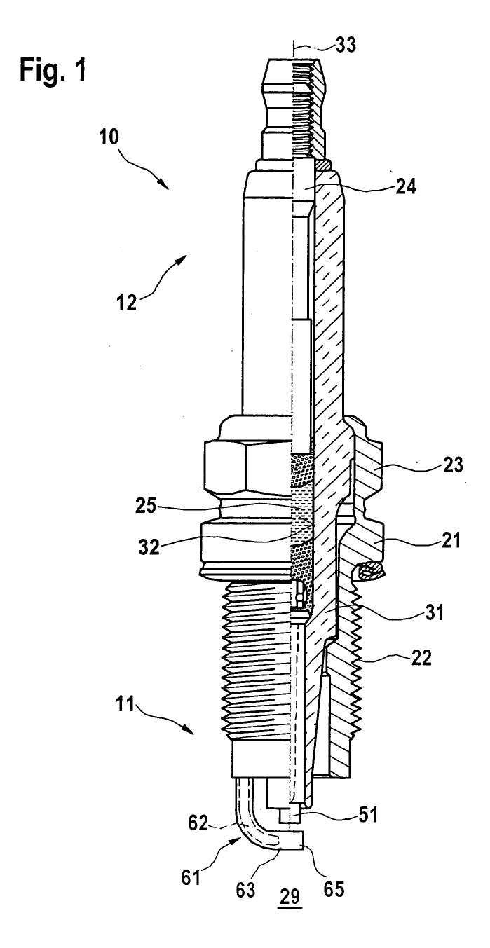

FIG. 1 shows, as the first exemplary embodiment of the present invention, a spark plug 10 having an 11 at the combustion chamber end, and a connecting end 12. Spark plug 10 includes a metallic housing 21, that is provided with a screw thread 22 and a hexagon drive 23. Spark plug 10 is screwed, using its screw thread 22, into a mating thread in the cylinder head of an internal combustion engine, using a tool that engages hexagon drive 23, so that spark plug 10 projects with its 11, that is on the combustion chamber end, into a combustion chamber 29 of a cylinder of the internal combustion engine.

A ceramic insulator 31 is fixed gas-tight in housing 21. Insulator 31 has a longitudinal bore 32 having an axis of symmetry which forms longitudinal axis 33 of insulator 31, and therewith of spark plug 10. In longitudinal bore 32 of insulator 31, at the connecting end, a connecting bolt 24, and at the combustion chamber end, a central electrode 51 have been applied. Connecting bolt 24 and center electrode 51 are electrically connected by a resistor element 25, that is also situated in longitudinal bore 32 of insulator 31, which, when a high voltage is applied to the connecting bolt 24, acts in a current-limiting fashion. Resistor element 25 includes a resistor section and two contact sections, the resistor section being electrically connected by one contact section in each case to connecting bolt 24 and to center electrode 51. At combustion chamber 11 of spark plug 10, insulator 31 extends out of housing 21. Center electrode 51 extends out over the end face of insulator 31 and into combustion chamber 29.

A ground electrode 61 is fixed to housing 21. Ground electrode 61 has a core 62 made of a good heat-conducting material that is surrounded by a jacket 63. The material of core 62 is copper. The jacket includes a nickel alloy. Alternatively, core 63 may include an iron-chromium alloy or Inconel 601. Thus, the material of jacket 63 has a lower heat conductivity than the material of core 62.

Ground electrode 61 is formed as a top electrode which, starting from housing 21 first extends in a direction parallel to longitudinal axis 33 of spark plug 10 and bends 90 degrees towards center electrode 51 so that an end section 65 of ground electrode 61 extends past center electrode 51, that is, right into the region of longitudinal axis 33 of spark plug 10 (spark air plug). By the application of a high voltage, a spark gap forms between center electrode 51 and center section 65 of ground electrode 61. At end section 65 of ground electrode 61 a noble metal section (not shown) may be provided.

Ground electrode 61 is made of metallic starting elements by extrusion. Subsequently, ground electrode 61 is welded onto housing 21 of spark plug 10, and is then bent in the shape of a hook, so that end section 65 of ground electrode 61 lies opposite center electrode 51.

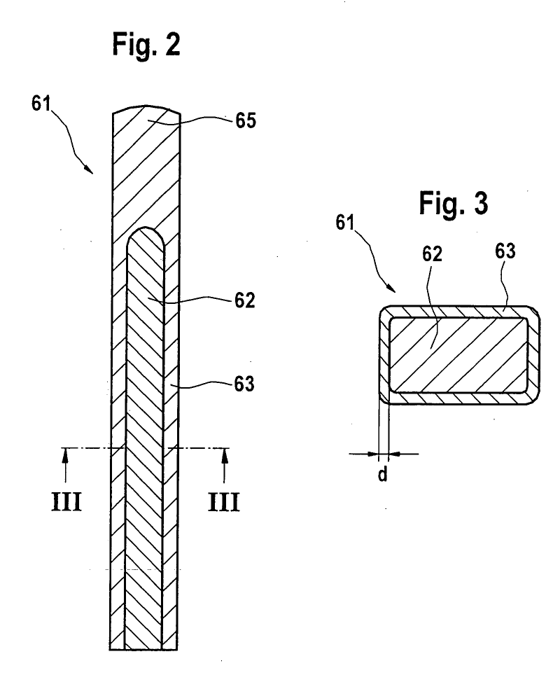

FIGS. 2 and 3 show a ground electrode 61 before the bending process (or rather, after unrolling bent ground electrode 61 to lie in a plane). Ground electrode 61 and its core 62 are shaped largely rectangularly in cross section, the edges being rounded off in each case. Core 62 of ground electrode 61 extends over approximately 75 percent of the length of ground electrode 61. The cross sectional area of core 62 is approximately constant over nearly its entire length. The wall thickness of jacket 63 amounts to about 0.3 mm.

1. A spark plug comprising:
a housing;
a ground electrode fixed on the housing, the ground electrode having a core and a jacket, a material of the core having a higher heat conductivity than a material of the jacket, a cross-sectional area of the core amounting, at least from section to section, to at least 40 percent of a cross-sectional area of the ground electrode; and
an insulator situated in the housing, the insulator having a longitudinal bore having a center electrode.

2. The spark plug according to claim 1, wherein the cross-sectional area of the core amounts to at least 10 percent of the cross-sectional area of the ground electrode, over at least half a length of the ground electrode.

3. The spark plug according to claim 2, wherein the cross-sectional area of the core amounts to at least 50 percent of the cross-sectional area of the ground electrode, over at least 65 percent of the length of the ground electrode.

4. The spark plug according to claim 1, wherein the core of the ground electrode extends to the housing.

5. The spark plug according to claim 1, wherein an extension of the core along a longitudinal extension of the ground electrode amounts to at least 70 percent of a length of the ground electrode.

6. The spark plug according to claim 1, wherein the cross-sectional area of the core of the ground electrode is at least substantially constant over at least 70 percent of a longitudinal extension of the core, being submitted to fluctuations of at most 10 percent.

7. The spark plug according to claim 1, wherein a wall strength of the jacket of the ground electrode, in a region of the core, is in a range of 0.25 mm to 0.40 mm.

8. The spark plug according to claim 7, wherein the wall strength is about 0.30 mm.

9. The spark plug according to claim 1, wherein the material of the core of the ground electrode has a heat conductivity of at least 350 W/mK at room temperature.

10. The spark plug according to claim 1, wherein a heat conductivity of the material of the core of the ground electrode at room temperature is greater by at least 300 W/mK than a heat conductivity of the material of the jacket of the ground electrode.
